(19) United States
(12) Patent Application Publication
(10) Pub. No.: US 2022/0275946 A1
(43) Pub. Date: Sep. 1, 2022

(54) DOOR ASSEMBLY AND COOKING DEVICE

(71) Applicants: GUANGDONG MIDEA KITCHEN APPLIANCES MANUFACTURING CO., LTD., FOSHAN (CN); MIDEA GROUP CO., LTD, FOSHAN (CN)

(72) Inventors: Modam JOO, FOSHAN (CN); Shiyong LIU, FOSHAN (CN); Li HONG, FOSHAN (CN)

(21) Appl. No.: 17/412,116

(22) Filed: Aug. 25, 2021

(30) Foreign Application Priority Data
Feb. 26, 2021 (CN) 202110216491.3

(51) Int. Cl. F24C 15/02; F24C 7/02; F24C 7/08

(52) U.S. Cl. CPC F24C 15/022; F24C 7/02; F24C 7/082

(57) ABSTRACT

The present application belongs to the field of cooking appliances, and relates to a door assembly and a cooking device. The door assembly of the present application includes a door panel, a control panel and a locking member. The door panel is provided with a first mounting hole penetrating the door panel, the control panel is provided with a second mounting hole arranged opposite to the first mounting hole, and the locking member includes a connecting end and a fixing end; the connecting end can pass through the first mounting hole and be inserted into the second mounting hole for connecting the door panel and the control panel, and the door panel is located between the locked control panel and the fixing end. According to the door assembly of the present application, the connecting end of the locking member passes through the first mounting hole on the door panel and the second mounting hole on the control panel in sequence, and the fixing end is placed on a side of the door panel that is away from the control panel.

### CROSS-REFERENCES TO RELATED APPLICATIONS

The present application claims benefit of Chinese Application No. 202110216491.3, filed on Feb. 26, 2021, the contents of which are hereby incorporated by reference in its entirety.

### FIELD

The present application belongs to the field of cooking appliances, and relates to a door assembly and a cooking device.

### BACKGROUND

With the improvement of consumer's living standards, cooking utensils such as ovens or microwave ovens are becoming more and more popular. With the increase of recreational vehicle (RV) equipment, over the range (OTR) products are provided in RVs to further meet user's requirements on products. An oven door of OTR product is generally locked by a door pin, and a spring structure arranged on the cabinet. A locking force of the oven door is very small, typically only 3-4 kgf, so that the user can open the oven door of the OTR product through a one-handed operation. However, when the vehicle bumps or is subjected to other external forces during running, the oven door will be opened under the action of force due to the vibration, which will easily cause scratches to the people in the vehicle and even cause the oven door to be opened during the OTR work process, thus leading to unnecessary safety accidents and therefore reducing the user's experience.

### SUMMARY

One embodiment of the present application is to at least solve the problem that the oven door of the OTR is prone to automatic opening under the action of an external force.

One embodiment of the present application proposes a door assembly, which includes:

a door panel, which is provided with a first mounting hole penetrating the door panel;

a control panel, which is provided with a second mounting hole arranged opposite to the first mounting hole; and

a locking member, which includes a connecting end and a fixing end, in which the connecting end can pass through the first mounting hole and be inserted into the second mounting hole for connecting the door panel and the control panel, and the door panel is located between the locked control panel and the fixing end.

According to the door assembly of the present application, the connecting end of the locking member passes through the first mounting hole on the door panel and the second mounting hole on the control panel in sequence, and the fixing end is placed on a side of the door panel that is away from the control panel; by clamping and fixing the door panel through the fixing end and the control panel, the door panel can be effectively prevented from being opened automatically under the action of an external force, thus avoiding safety accidents and further improving the reliability and safety of the door assembly during use.

In addition, the door assembly according to the present application may also have the following additional embodiments.

In some embodiments of the present application, an outer peripheral surface of the connecting end is provided with an external thread, an interior of the second mounting hole is provided with an internal thread, and the connecting end is inserted into the interior of the second mounting hole and is threaded with the second mounting hole.

In some embodiments of the present application, an end of the connecting end is provided with at least one mounting protrusion protruding out of an outer peripheral surface of the connecting end, the second mounting hole is provided therein with at least one through groove cooperating with the at least one mounting protrusion, and the at least one mounting protrusion can be inserted into the at least one through groove and project outside of the second mounting hole.

In some embodiments of the present application, the door assembly further includes a fixing member that is inserted into the second mounting hole, an interior of the fixing member is provided with a third mounting hole arranged in an axial direction of the second mounting hole, and the connecting end is inserted into the third mounting hole.

In some embodiments of the present application, an outer peripheral surface of the connecting end is provided with an external thread, an interior of the third mounting hole is provided with an internal thread, and the connecting end is inserted into the interior of the third mounting hole and is threaded connected with the third mounting hole.

In some embodiments of the present application, an end of the connecting end is provided with at least one mounting protrusion protruding out of an outer peripheral surface of the connecting end, the third mounting hole is provided therein with at least one through groove cooperating with the at least one mounting protrusion, and the at least one mounting protrusion can be inserted into the at least one through groove and project outside of the third mounting hole.

In some embodiments of the present application, the door assembly further includes a positioning pin, the connecting end and the fixing end are connected by a support section, an end of the support section that is close to the connecting end is provided with a positioning hole, the positioning pin is inserted into the positioning hole, and an axial length of the positioning pin is larger than a diameter of the third mounting hole.

In some embodiments of the present application, an end of the fixing end that is away from the door panel is provided with a holding portion protruding out of the fixing end.

In some embodiments of the present application, the door assembly further includes a buffering member, which is sleeved over an outside of the locking member and is arranged between the door panel and the fixing end.

Another embodiment of the present application also provides a cooking device, which has the door assembly described in any of the above solutions.

### BRIEF DESCRIPTION OF THE DRAWINGS

The accompanying drawings are only used for the purpose of illustrating embodiments, and should not be considered as a limitation to the present disclosure. Moreover, throughout the drawings, the same reference numerals are used to denote the same components, in which:

FIG. 1 is a schematic front view of the structure of a door assembly of the present embodiment;

FIG. 2 is a schematic exploded view of the structure of the door assembly in FIG. 1;

FIG. 3 is a schematic cross-sectional structural view taken along line A-A in FIG. 1;

FIG. 4 is a schematic view of an enlarged structure of part B in FIG. 3;

FIG. 5 is a schematic view of a connection structure between a locking member and a positioning pin in FIG. 2;

FIG. 6 is a schematic structural view of a locking member in another embodiment;

and

FIG. 7 is a schematic structural view of a fixing member that cooperates with the locking member in FIG. 6 in another embodiment.

The reference numbers in the drawings are listed as follows:
100: door assembly;
10: door panel; 11: door panel body; 111: first mounting hole; 112: transparent plate; 12: door outer cover; 13: door inner cover;
20: control panel; 21: upper support plate; 211: second mounting hole; 22: lower support plate; 23: transition plate;
30: locking member; 31: connecting end; 311: mounting protrusion; 32: fixing end;
33: support section; 34: holding portion;
40: fixing member; 41: third mounting hole; 411: through groove;
50: hinge;
60: positioning pin.

### DETAILED DESCRIPTION OF THE DISCLOSURE

Hereinafter, exemplary embodiments of the present disclosure will be described in more detail with reference to the accompanying drawings. Although the exemplary embodiments of the present disclosure are shown in the drawings, it should be understood that the present disclosure may be implemented in various forms and should not be limited by the embodiments set forth herein.

It should be understood that the terms used herein are only for the purpose of describing specific exemplary embodiments, and are not intended to be limitative. Unless clearly indicated otherwise in the context, singular forms “a”, “an”, and “said” as used herein may also mean that plural forms are included. Terms “include”, “comprise”, “contain” and “have” are inclusive, and therefore indicate the existence of the stated features, steps, operations, elements and/or components, but do not exclude the existence or addition of one or more other features, steps, operations, elements, components, and/or combinations thereof. The method steps, processes, and operations described herein should not be interpreted as requiring them to be executed in the specific order described or illustrated, unless the order of execution is clearly indicated. It should also be understood that additional or alternative steps may be used.

Although terms “first”, “second”, “third” and the like may be used herein to describe multiple elements, components, regions, layers and/or sections, these elements, components, regions, layers and/or sections should not be limited by these terms. These terms may only be used to distinguish one element, component, region, layer or section from another region, layer or section. Unless clearly indicated in the context, terms such as “first”, “second” and other numerical terms do not imply an order or sequence when they are used herein. Therefore, the first element, component, region, layer or section discussed below may be referred to as a second element, component, region, layer or section without departing from the teachings of the exemplary embodiments.

For ease of description, spatial relative terms may be used herein to describe the relationship of one element or feature relative to another element or feature as shown in the drawings. These relative terms are, for example, “inner”, “outer”, “inside”, “outside”, “below”, “under”, “above”, “over”, etc. These spatial relative terms are intended to include different orientations of the device in use or in operation in addition to the orientation depicted in the drawings. For example, if the device in the figure is turned over, then elements described as “below other elements or features” or “under other elements or features” will be oriented as “above the other elements or features” or “over the other elements or features”. Thus, the exemplary term “below” may include orientations of both above and below. The device can be otherwise oriented (rotated by 90 degrees or in other directions), and the spatial relationship descriptors used herein will be explained accordingly.

As shown in FIG. 1 to FIG. 4, the door assembly of this embodiment is used in cooking devices, such as a vehicle-mounted OTR device, a microwave oven, etc., or other scenes that are susceptible to external vibration forces. The door assembly 100 includes a door panel 10, a control panel 20, and a locking member 30. The door panel 10 is provided with a first mounting hole 111 penetrating the door panel 10, and the control panel 20 is provided with a second mounting hole 211 arranged opposite to the first mounting hole 111. The locking member 30 includes a connecting end 31 and a fixing end 32. The connecting end 31 can pass through the first mounting hole 111 and be inserted into the second mounting hole 211 for connecting the door panel 10 and the control panel 20, and the door panel 10 is located between the locked control panel 20 and the fixing end 32.

According to the door assembly 100 of the present application, the connecting end 31 of the locking member 30 passes through the first mounting hole 111 on the door panel 10 and the second mounting hole 211 on the control panel 20 in sequence, and the fixing end 32 is placed on a side of the door panel 10 that is away from the control panel 20. The door panel 10 is clamped and fixed by the fixing end 32 and the control panel 20, and effectively preventing the door panel 10 of the door assembly from being automatically opened under the action of an external force, thus avoiding safety accidents and further improving the reliability and safety of the door assembly 100 during use.

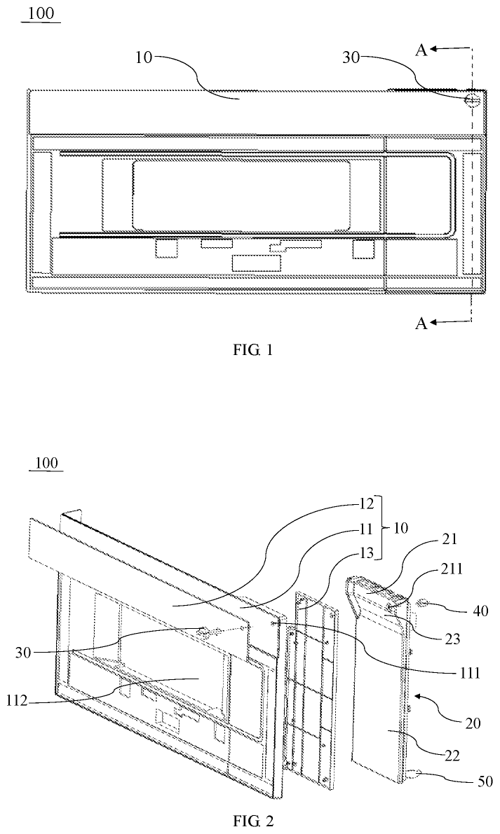

In one embodiment, as shown in FIGS. 2 to 4, the door panel 10 of this embodiment includes a door panel body 11, a door outer cover 12 and a door inner cover 13. The door outer cover 12 fits an outer surface of a top of the door panel body 11. The door inner cover 13 fits a side of an inner surface of the door panel body 11, and is arranged opposite to the control panel 20. The first mounting hole 111 sequentially penetrates the door panel body 11, the door outer cover 12 and the door inner cover 13, so that a passage for the connecting end 31 of the locking member 30 to pass through is formed on the door panel 10. The door panel body 11 is also provided with a transparent plate 112 at a central position of plate surface. When the door assembly 100 is connected to a cabinet of the cooking device, the transparent plate 112 can be arranged opposite to a cooking chamber in the cabinet, and facilitating the user to observe a heating state of food in the cooking chamber through the transparent plate 112 from the outside of the cooking device, to control the cooking device. In one embodiment, the transparent plate may be a glass plate.

With reference to FIGS. 2 and 3, the control panel 20 of this embodiment includes an upper support plate 21, a lower support plate 22, and a transition plate 23. The transition plate 23 extends in a direction toward the door panel 10, and is configured to connect the upper support plate 21 with the lower support plate 22 and make the upper support plate 21 to be arranged closer to the door panel 10 than the lower support plate 22, so that the upper support plate 21 is connected to the door panel 10 and a gap is reserved between the lower support plate 22 and the door panel 10 for installation of operation keys, which enable the control panel 20 to control the cooking device. The second mounting hole 211 arranged opposite to the first mounting hole 111 is provided on the upper support plate 21. A bottom of the lower support plate 22 is provided with a hinge 50 for connecting with the cabinet. The hinge 50 passes through the lower support plate 22 and is rotatably connected with the door panel 10 to realize the rotation of the door panel 10, and opening or closing the cooking chamber of the cooking device.

As shown in FIGS. 2 to 4 again, the door assembly 100 of this embodiment further includes a fixing member 40 that is inserted into the second mounting hole 211. An interior of the fixing member 40 is provided with a third mounting hole 41 arranged in an axial direction of the second mounting hole 211, and the connecting end 31 is inserted into the third mounting hole 41. In one embodiment, the fixing member 40 is detachably arranged in the second mounting hole 211. Since there will be a friction between the connecting end 31 of the locking member 30 and the fixing member 40 in the process of opening or closing the door panel 10, the fixing member 40 will be worn after long-time use, which leads to deterioration of the locking effect. By substituting a new fixing member 40, the locking effect between the connecting end 31 and the fixing member 40 can be ensured. In other embodiments of the present application, the fixing member 40 may also be welded to the interior of the second mounting hole 211.

In one embodiment, an outer peripheral surface of the connecting end 31 of the locking member 30 of this embodiment is provided with an external thread (not shown in the figure), an interior of the third mounting hole 41 is provided with an internal thread, and the connecting end 31 is inserted into the interior of the third mounting hole 41 and is threaded connected with the third mounting hole 41. By passing the connecting end 31 through the first mounting hole 111, and the third mounting hole 41 in the second mounting hole 211 in sequence, and rotating the locking member 30 so that the connecting end 31 and the fixing member 40 are is threaded connected, the door panel 10 is fixed between the fixing end 32 and the control panel 20 so that the door panel 10 is clamped and fixed, and effectively preventing the door panel 10 from being opened automatically under the action of an external force, avoiding safety accidents, and further improving the reliability and safety of the door assembly 100 during use.

With reference to FIGS. 2 to 5 again, the locking member 30 of this embodiment includes the connecting end 31, a support section 33, and the fixing end 32 arranged in the axial direction in sequence. The connecting end 31 is configured to connect the fixing member 40; the fixing end 32 is configured to clamp the door panel 10 together with the control panel 20 to prevent the door panel 10 from being opened automatically under the action of an external force; and the support section 33 is configured to connect the fixing end 32 and the connecting end 31. An end of the fixing end 32 that is away from the door panel 10 is provided with a holding portion 34 protruding out of the fixing end 32. The arrangement of the holding portion 34 facilitates the user to insert and rotate the locking member 30 accordingly, and facilitating the user's operation. The specific structure and shape of the holding portion 34 are not limited, and this embodiment only uses the “-” shape, which is easy to process, as an example for description.

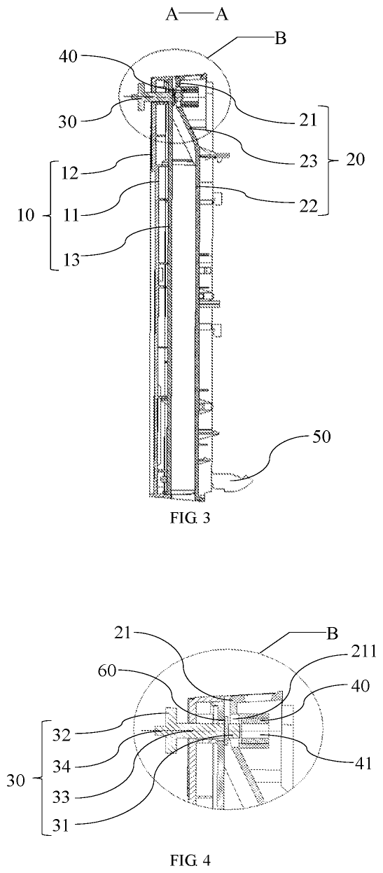

Further, as shown in FIG. 4 and FIG. 5, the door assembly 100 of this embodiment further includes a positioning pin 60. The support section 33 of this embodiment is provided with a positioning hole at an end close to the connecting end 31 (that is, at a position where the positioning pin 60 is inserted into the support section 33 in FIG. 5). The positioning pin 60 is inserted into the positioning hole, and an axial length of the positioning pin 60 is larger than a diameter of the third mounting hole 41, so that an insertion length of the locking member 30 is restricted by the positioning pin 60, and other components in the cooking device are prevented from being squeezed or even damaged due to the excessive insertion length of the locking member 30. A distance between the positioning hole for mounting the positioning pin 60 and an end of the connecting end 31 in the insertion direction is smaller than or equal to an axial length of the fixing member 40, to ensure that the end of the connecting end 31 in the insertion direction is always retained inside the fixing member 40.

In one embodiment, before the door panel 10 is closed, the connecting end 31 of the locking member 30 may be inserted into the first mounting hole 111 and project outside of the first mounting hole 111, and then the positioning pin 60 may be inserted into the positioning hole of the support section 33 so that the positioning pin 60 and the locking member 30 are assembled. In order to prevent the positioning pin 60 from falling off during the insertion and rotation of the locking member 30, the diameter of the positioning pin 60 gradually increases in the axial direction. The diameter of one end of the positioning pin 60 is smaller than the diameter of the positioning hole, and the diameter of the other end of the positioning pin 60 is larger than the diameter of the positioning hole. As the positioning pin 60 is inserted into the positioning hole, the positioning pin 60 and the positioning hole are changed from a clearance fit to an interference fit, and fixing the positioning pin 60 to the locking member 30.

Further, the diameter of the first mounting hole 111 is larger than the length of the positioning pin 60 and smaller than the diameter of the fixing end 32. The positioning pin 60 can be assembled with the positioning hole in advance; then the connecting end 31 of the locking member 30 passes through the first mounting hole 111 and is inserted into the second mounting hole 211, and the locking member 30 abuts an outside surface of the door panel 10 through the fixing end 32 to finally lock the door panel 10 tightly through the cooperation with the control panel 20.

Further, the door assembly 100 of this embodiment further includes a buffering member (not shown in the figure), and the buffering member is sleeved over the outside of the locking member 30 and is arranged between the door panel 10 and the fixing end 32. After the connecting end 31 is inserted into the interior of the fixing member 40 and is threaded fitted with the fixing member 40, in order to ensure that the fixing end 32 has a pressing force on the door panel 10 and no scratches will be caused to the outer surface of the door panel 10, a buffering member is provided between the door panel 10 and the fixing end 32, so that a corresponding pressing force is provided to the door panel 10 through the squeezing deformation of the buffering member, without causing scratches to the door panel 10.

In other embodiments of the present application, the fixing member 40 may also be omitted. An internal thread is directly provided in the second mounting hole 211 of the control panel 20, and the connecting end 31 is inserted into the interior of the second mounting hole 211 and is threaded connected with the second mounting hole 211 so that the locking member 30 and the control panel 20 are connected and fixed and they together fix and clamp the door panel 10, thus preventing the door panel 10 from be automatically opened under the action of an external force.

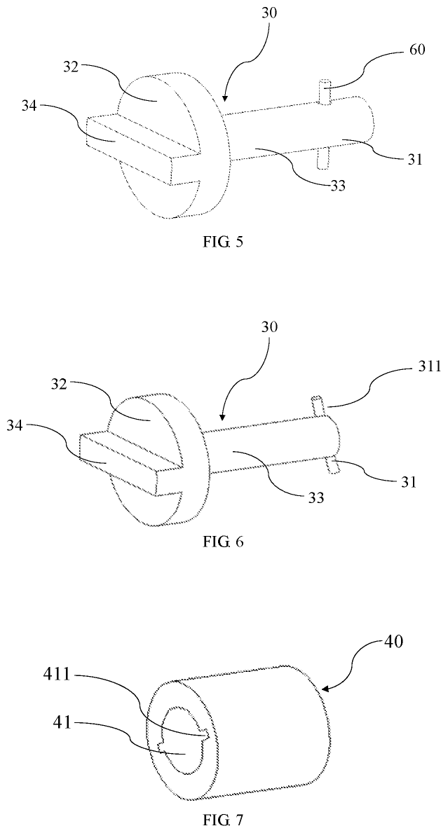

In other embodiments of the present application, structures other than the threaded structure may also be used to connect the locking member 30 and the fixing member 40. As shown in FIG. 6 and FIG. 7, the end of the connecting end 31 in this embodiment is provided with two mounting protrusions 311 protruding out of the outer peripheral surface of the connecting end 31, and the two mounting protrusions 311 are arranged on the outer peripheral surface of the end of the connecting end 31 at an interval. The third mounting hole 41 is provided with two through grooves 411 that cooperate with the two mounting protrusions 311, and the angular interval of the two through grooves 411 is the same as the angular interval of the two mounting protrusions 311. The two mounting protrusions 311 can be inserted into the two through grooves 411 at the same time and protrude out of the third mounting hole 41. Moreover, the through grooves 411 and the mounting protrusions 311 are staggeredly arranged by a rotational angle, so that the locking member 30 and the control panel 20 are connected and fixed and they together fix and clamp the door panel 10, thus preventing the door panel 10 from be automatically opened under the action of an external force. When the door panel 10 needs to be opened, the locking member 30 is rotated, and the two mounting protrusions 311 and the two through grooves 411 are respectively arranged in a one-to-one correspondence, so that the locking member 30 can be withdrawn to realize the opening of the door panel 10. In other embodiments of the present application, one or more mounting protrusions 311 may also be provided on the outer peripheral surface of the end of the connecting end 31, and the third mounting hole 41 may be provided with through grooves 411 with the same number as the mounting protrusions 311, to realize the insertion process between the connecting end 31 and the fixing member 40.

In other embodiments of the present application, at least one mounting protrusion 311 protruding out of the outer peripheral surface of the connecting end 31 may also be provided at the end of the connecting end 31, and at least one through groove 411 cooperating with the at least one mounting protrusion 311 is provided in the second mounting hole 211 of the control panel 20. By inserting the mounting protrusion 311 into the through groove 411 and making it protrude outside of the second mounting hole 211, the locking member 30 and the control panel 20 are connected and fixed.

What is claimed is:

1. A door assembly, comprising:
a door panel, provided with a first mounting hole penetrating the door panel;
a control panel, provided with a second mounting hole arranged opposite to the first mounting hole; and
a locking member, which comprises a connecting end and a fixing end, wherein the connecting end can pass through the first mounting hole and be inserted into the second mounting hole for connecting the door panel and the control panel, and the door panel is located between a locked control panel and the fixing end.

2. The door assembly according to claim 1, wherein an outer peripheral surface of the connecting end is provided with an external thread, an interior of the second mounting hole is provided with an internal thread, and the connecting end is inserted into the interior of the second mounting hole and is threaded with the second mounting hole.

3. The door assembly according to claim 1, wherein an end of the connecting end is provided with at least one mounting protrusion protruding out of an outer peripheral surface of the connecting end, the second mounting hole is provided therein with at least one through groove cooperating with the at least one mounting protrusion, and the at least one mounting protrusion can be inserted into the at least one through groove and project outside of the second mounting hole.

4. The door assembly according to claim 1, further comprising a fixing member that is inserted into the second mounting hole, wherein an interior of the fixing member is provided with a third mounting hole arranged in an axial direction of the second mounting hole, and the connecting end is inserted into the third mounting hole.

5. The door assembly according to claim 4, wherein an outer peripheral surface of the connecting end is provided with an external thread, an interior of the third mounting hole is provided with an internal thread, and the connecting end is inserted into the interior of the third mounting hole and is threaded with the third mounting hole.

6. The door assembly according to claim 4, wherein an end of the connecting end is provided with at least one mounting protrusion protruding out of an outer peripheral surface of the connecting end, the third mounting hole is provided therein with at least one through groove cooperating with the at least one mounting protrusion, and the at least one mounting protrusion can be inserted into the at least one through groove and project outside of the third mounting hole.

7. The door assembly according to claim 4, further comprising a positioning pin, wherein the connecting end and the fixing end are connected by a support section, an end of the support section that is close to the connecting end is provided with a positioning hole, the positioning pin is inserted into the positioning hole, and an axial length of the positioning pin is larger than a diameter of the third mounting hole.

8. The door assembly according to claim 1, wherein an end of the fixing end that is away from the door panel is provided with a holding portion protruding out of the fixing end.

9. The door assembly according to claim 1, further comprising a buffering member sleeved over an outside of the locking member and is arranged between the door panel and the fixing end.

10. A cooking device, comprising:
a door assembly, comprising:
a door panel, which is provided with a first mounting hole penetrating the door panel;
a control panel, which is provided with a second mounting hole arranged opposite to the first mounting hole; and
a locking member, which comprises a connecting end and a fixing end, wherein the connecting end can pass through the first mounting hole and be inserted into the second mounting hole for connecting the door panel and the control panel, and the door panel is located between a locked control panel and the fixing end.
